(19) United States
(12) Patent Application Publication
(10) Pub. No.: US 2025/0240573 A1
(43) Pub. Date: Jul. 24, 2025

(54) LOUDSPEAKER

(71) Applicant: ASK Industries S.p.A., MONTE SAN VITO (IT)

(72) Inventor: Claudio PANNI, MONTE SAN VITO (IT)

(21) Appl. No.: 19/024,082

(22) Filed: Jan. 16, 2025

(30) Foreign Application Priority Data
Jan. 24, 2024 (IT) 102024000001311

(51) Int. Cl. H04R 7/12; H04R 9/02; H04R 9/04; H04R 9/06

(52) U.S. Cl. CPC H04R 7/122; H04R 7/127; H04R 9/025; H04R 9/045; H04R 9/046; H04R 9/06; H04R 2400/11

(57) ABSTRACT

A loudspeaker having a frame, a diaphragm, a support element for the diaphragm, and a magnetic circuit that includes a yoke, a core and a magnet. The yoke and the core form an air gap. An upper portion of a coil is connected to the diaphragm and a lower portion of the coil is in the air gap. The diaphragm includes inner, outer and intermediate annular portions. The inner annular portion includes an arch-shaped first central section and a first inner edge connected to the support element and a first outer edge. The outer annular portion includes an arch-shaped second central section, a second inner edge and a second outer edge connected to the frame. The intermediate annular portion includes a dome-shaped section with downwardly-facing concavity and from which a funnel-shaped section extends. The funnel-shaped section converges towards the support element and is connected to the first outer edge.

The present disclosure relates to a loudspeaker.

As is well known, some loudspeakers currently on the market, for example of the type also referred to as tweeters, include a diaphragm or membrane that is placed in vibration in order to generate sound waves.

For this purpose, loudspeakers use a vibration-generating assembly that includes a coil operatively coupled to the membrane, and a magnetic circuit operatively associated with the coil.

The magnetic circuit is configured to generate a magnetic field whose fluctuations cause the coil to move in an ideally linear path along a vertical axis of the loudspeaker.

This movement is transferred to the membrane so that it vibrates.

Unfortunately, during the lifetime of loudspeakers, deviations or rocking of the diaphragm from an ideal operating condition may occur.

In such a condition, also referred to in the technique as ‘rocking’, the diaphragm may tilt and/or shift with respect to the reference axis, leading to distortion of the sound signals emitted by the loudspeaker.

Therefore, there is desire and room for further improvements.

Accordingly, the present disclosure provides a loudspeaker comprising at least:
a frame and, housed at least partially within the frame:
a diaphragm;
a support element for the diaphragm;
a magnetic circuit comprising a yoke, a core, and a magnet that is interposed between the yoke and the core, wherein said yoke has a cup-shaped body having a bottom wall from which a side wall rises, the magnet is housed within the yoke, resting directly against the back wall, and the core rests on the top surface of the magnet, opposite the bottom wall, said yoke and core forming an air gap between them;
a coil configured to move substantially linearly along a reference axis of the loudspeaker, said coil having an upper portion connected to the diaphragm and a lower portion inserted into said air gap; and in which said diaphragm comprises:
   an inner annular portion comprising a first central section arch-shaped, a first inner edge which is connected to the support element and a first outer edge, the first inner edge and the first outer edge protruding from sides opposite to each other of the arch-shaped first central section;
   an outer annular portion comprising a second central section arch-shaped, a second inner edge and a second outer edge that is connected to the frame, the second inner edge and the second outer edge protruding from sides opposite to each other of the arch-shaped second central section; and
   an intermediate annular portion comprising a first section configured substantially as a dome, which is arranged with its concavity facing downward and is connected, along its outer edge, to said second inner edge of the outer annular portion, and a second section configured substantially as a funnel, which extends from the first dome-shaped section converging toward the supporting element and is connected to said first outer edge of the inner annular portion.

According to some embodiments, the loudspeaker according to the present disclosure may comprise one or more of the following features, which may be combined in any technical feasible combination:
the first inner edge of the inner annular portion extends around and surrounds a central aperture;
the support element comprises a shaped body having a base attached to the core of the magnetic circuit, and an upper portion having a first attachment surface, substantially parallel to the base, to which the first inner edge is fixed, and a centering tooth which rises from the first attachment surface, substantially along the reference axis, and is inserted passing through the central aperture;
the frame has a shaped body having a second attachment surface to which the second outer edge of the outer annular portion is fixed, the second attachment surface lying in a transverse plane with respect to the reference axis;
the first and second attachment surfaces lie in two corresponding planes spaced apart and substantially parallel to each other;
the frame has a shaped body having a wall having a substantially cylindrical development which is arranged around the yoke and has, at an upper inner edge thereof, a protruding tooth;
the side wall of the yoke has, at its upper outer edge, a step suitable for resting against said protruding tooth;
the coil comprises an armature around which is arranged at least one winding, said armature being attached, along an upper edge thereof, to the intermediate annular portion of the diaphragm.

Further features and advantages of the disclosure will appear from the following detailed description, carried out by way of non-limiting example only, with reference to the accompanying drawings, in which:

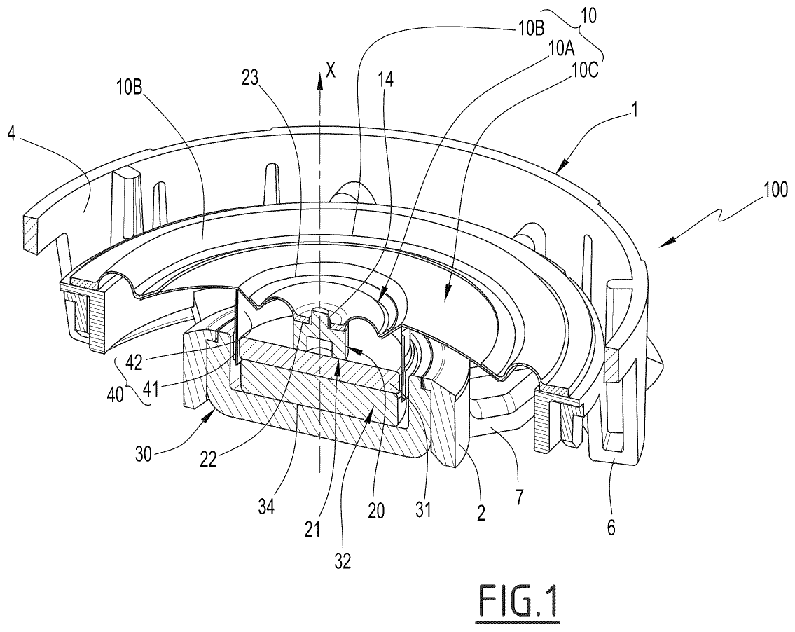

FIG. 1 is a view of a loudspeaker according to the present disclosure, shown partially cut to better illustrate its components;

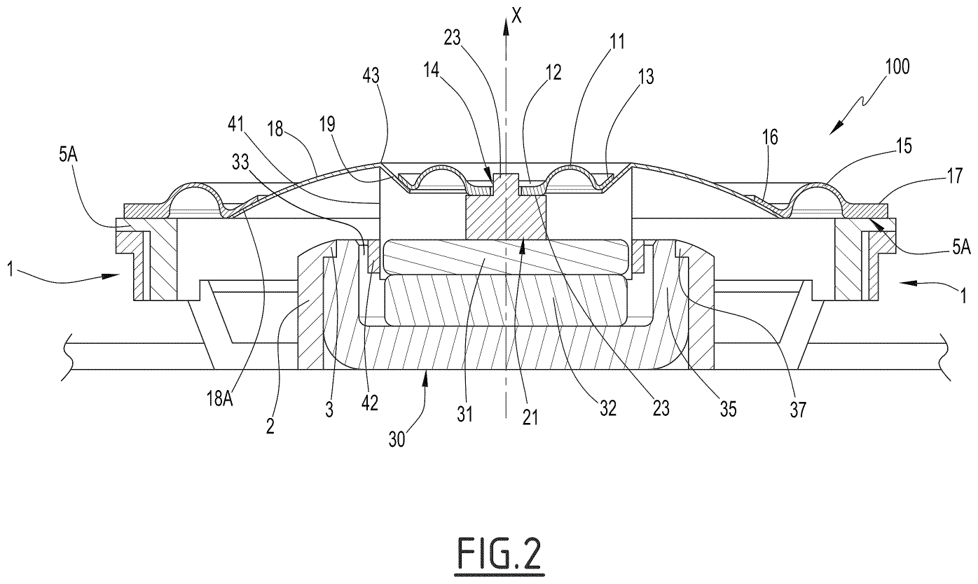

FIG. 2 is a partial sectional view of a loudspeaker according to the present disclosure, with the outermost part of the frame not shown.

It should be noted that in the following detailed description, identical or similar components, from a structural and/or functional point of view, may have the same or different reference numbers, regardless of whether they are shown in different embodiments of the present disclosure or in separate parts.

It should also be noted that, in order to clearly and concisely describe the present disclosure, the drawings may not necessarily be to scale and some features of the description may be shown in a somewhat schematic form.

Furthermore, when the term “adapted”, or “configured”, or “shaped”, or any similar term is used herein, referring to any component as a whole, or to any section of a component or to a combination of components, it shall be understood to mean and include the structure and/or configuration and/or shape and/or positioning accordingly.

In addition, when the term “approximately” or “substantially” is used herein, it is to be understood as encompassing a current variation of plus or minus 5% with respect to what is indicated as the reference value or position or axis, and when the terms “transverse” or “transversely” are used herein, they are to be understood as encompassing a direction that is not parallel to the reference section(s)/axis(s) to which they refer, and perpendicularity is to be considered a specific case of transverse direction.

FIGS. 1 and 2 illustrate a loudspeaker according to the disclosure, indicated by the overall reference number 100, comprising at least:
a frame (or chassis) 1 and, housed at least partially within the frame 1:
   a diaphragm (or membrane) 10;
   a support element 20 for diaphragm 10;
   a magnetic circuit comprising a yoke 30, a core or upper metal disc 31, and a magnet 32 which is interposed between the yoke 30 and the core 31. The yoke 30 and the core 31 are configured and mutually arranged to form an air gap 33 between them;
   a coil 40 that is configured to move substantially linearly along an X reference axis, in particular a vertical axis of substantially symmetry for the loudspeaker 100.

In particular, the coil 40 has an upper portion connected to diaphragm 10 and a lower portion inserted into air gap 33.

In the illustrated embodiment, the coil 40 comprises an armature 41, having, for example, a hollow cylindrical body, around which at least one winding 42 is arranged.

Usefully, the diaphragm 10 comprises three distinct portions having substantially annular development, namely an inner annular portion 10A, an outer annular portion 10B, and an intermediate annular portion 10C that is interposed between and connected to the inner annular portion 10A and the outer annular portion 10B.

In more detail, the inner annular portion 10A comprises a first central section 11 configured as an arc, from which protrude from opposite sides to the first central arch-shaped section 11, a first inner edge 12 which is connected, e.g. glued, to the support element 20, and a first outer edge 13.

The outer annular portion 10B also comprises a central section 15 configured in the shape of an arc (hereinafter referred to for illustrative clarity as the “second arch-shaped central section”) from which protrude, from opposite sides to each other with respect to the second arch-shaped central section 15, an inner edge 16 (hereinafter referred to for illustrative clarity as the “second inner edge”), and an outer edge 17 which is connected, e.g. glued, to the frame 1 (hereinafter referred to for illustrative clarity as the “second outer edge”).

The intermediate annular portion 10C comprises a first section 18 configured substantially as a dome and a second section 19 configured substantially as a funnel.

In particular, the first dome section 18 is arranged with its concavity facing downwards (i.e. facing, for example, the coil 40 and/or the magnetic circuit), and is connected, along one of its outer edges 18A, to the second inner edge 16 of the outer annular portion 10B.

The second funnel-shaped section 19 protrudes from the first domed section 18, converging towards the supporting element 20, and is connected to the first outer edge 13 of the inner annular section.

In practice, the inner annular portion 10A and the outer annular portion 10B act as suspension elements for the intermediate annular portion 10C.

In a possible embodiment, the armature 41 is fixed, e.g. glued, along one of its upper edges 43, to the intermediate annular portion 10C.

In particular, this fixation takes place near or right along the transition zone between the dome section 18 and the funnel section 19.

Usefully, the yoke 30 has a cup-shaped body (seen in section it has a U-shaped configuration) with a back wall 34 from which a side wall 35 rises.

Conveniently, the magnet 32 is housed inside the yoke 30, resting directly against the back wall 34, e.g. glued, and the core 31 rests on the upper surface of the magnet 32, opposite the back wall 34, e.g. glued.

In particular, the yoke 30, the core 31, and the magnet 32 are configured and arranged along the vertical reference axis X so as to assume a substantially symmetrical configuration with respect to that reference axis X.

Furthermore, the core 31, in addition to the magnet 32, is also positioned within the height of the side wall 35, not protruding outside it or at most with its upper surface aligned with the upper edge of the side wall 35.

In a possible embodiment, the first inner edge 12 of the inner annular portion 10A develops around and surrounds a central opening 14.

In a possible embodiment of the loudspeaker 100 according to the disclosure, the frame 1 is conveniently realized so as to form a housing within which are housed at least partially, preferably completely, the diaphragm 10, the support element 20, the coil 40 and the magnetic circuit.

In a possible embodiment, the frame 1 has a shaped body having a fastening surface 5A to which the second outer edge 17 of the outer annular portion 10B is fixed, said second fastening surface 5A lying in a plane transverse to the reference axis X.

In particular, the fastening surface 5A lies in a horizontal plane, perpendicular to the X reference axis.

According to the examplary embodiment illustrated in FIGS. 1 and 2, the frame 1 has a shaped body, e.g. basket-shaped, which includes an inner part, an outer part, and an intermediate part.

The inner part of frame 1 comprises a substantially cylindrical wall 2 which is arranged around yoke 30.

In a possible embodiment, the wall 2 has a protruding tooth 3 at its upper inner edge.

The tooth 3 protrudes transversally from the wall 2 itself, inwards, i.e. towards the components of the magnetic circuit (or equivalently, towards the reference axis X).

The outer part of the frame 1 comprises an outer wall 4 (not illustrated in the section of FIG. 1), also substantially cylindrical in shape, which is arranged concentrically with the inner wall 2 with respect to the reference axis X.

The intermediate portion of the frame 1 comprises an annular portion which defines, in this embodiment, the attachment surface 5A for the outer annular portion 10B of the diaphragm 10, and in particular for its second outer edge 17.

The annular portion 5 is connected to the outer part 4 and to the inner wall 2 by one or more transverse arms, indicated in FIG. 1 by the respective reference numbers 6 and 7.

In a possible embodiment, the side wall 35 of the yoke 30, presents, at its upper outer edge, a step 37, having a configuration geometrically conjugated with that of the tooth 3 of the frame 1.

Conveniently, when the loudspeaker is assembled, the yoke 30 is placed on the inside of the wall 2 of the frame 1, with the step 37 resting against the tooth 3.

In this way, the tooth 3 stops the yoke 30 in the desired mounting position.

In a possible embodiment, the support element 20 comprises a body, e.g. substantially cylindrical in shape, which is arranged in a substantially central position along the reference axis X.

This substantially cylindrical body is attached, e.g., glued, at its base 21 to the core 31 of the magnetic circuit, and at its top, to the first inner edge 12 of the inner annular portion 10A.

In particular, according to a possible embodiment illustrated in FIGS. 1 and 2, the upper part of the support element 20 comprises a fixing surface 22, substantially parallel to the base 21, from which rises, substantially along the vertical reference axis X, a centring tooth 23.

The fastening surface 22 lies in a transverse plane with respect to the vertical reference axis X, and in particular in a horizontal plane perpendicular to the reference axis X.

Conveniently, the inner annular portion 10A of the diaphragm 10 is arranged with the first inner edge 12 resting on and connected, in particular glued, to the fixing surface 22 of the support element 20, with the centring tooth 23 being inserted through the central opening 14.

In particular, the attachment surface 22 lies in a substantially horizontal plane spaced from and parallel to the substantially horizontal plane in which the attachment surface 5A for the outer annular portion 10B of the diaphragm 10 lies.

In practice, it has been found that the loudspeaker 100 according to the disclosure fulfils the intended purposes in that, due to the design of the diaphragm and its connection to the frame 10 and the support element 20, it at least mitigates the phenomenon of ‘rocking’ of the diaphragm.

In addition, thanks to the configuration of the magnetic circuit and frame, as well as the arrangement of the various components, it has a more compact structure, in particular a smaller vertical footprint, compared to known loudspeakers.

In addition, compared to known loudspeakers, the loudspeaker 100 according to the disclosure has a structure that allows for easier and more precise assembly, which can be realised with optimised costs, and can offer high standards of acoustic performance.

Of course, without prejudice to the principle of the disclosure, the forms of implementation and details of embodiment may be widely varied with respect to what has been described and illustrated purely by way of preferred but not limiting examples, without thereby departing from the scope of protection of the present disclosure as defined in particular by the appended claims. For example, some of the components described above and/or one or more of their parts may be differently configured from what has been described as long as they remain compatible for the purposes and functionality envisaged within the present disclosure.

1. Loudspeaker comprising:
a frame;
a diaphragm;
a support element for the diaphragm;
a magnetic circuit comprising a yoke, a core, and a magnet that is interposed between the yoke and the core, wherein said yoke has a cup-shaped body having a bottom wall from which a side wall rises, the magnet is housed within the yoke, resting directly against the back wall, and the core rests on the top surface of the magnet, opposite the bottom wall, said yoke and core forming an air gap between them;
a coil configured to move substantially linearly along a reference axis of the loudspeaker, said coil having an upper portion connected to the diaphragm and a lower portion inserted into said air gap;
wherein said diaphragm comprises:
an inner annular portion comprising a first central section arch-shaped, a first inner edge which is connected to the support element and a first outer edge, the first inner edge and the first outer edge protruding from sides opposite to each other of the arch-shaped first central section;
an outer annular portion comprising a second central section arch-shaped, a second inner edge and a second outer edge that is connected to the frame, the second inner edge and the second outer edge protruding from sides opposite to each other of the arch-shaped second central section; and
an intermediate annular portion comprising a first section configured substantially as a dome, which is arranged with its concavity facing downward and is connected, along its outer edge, to said second inner edge of the outer annular portion, and a second section configured substantially as a funnel, which extends from the first dome-shaped section converging toward the supporting element and is connected to said first outer edge of the inner annular portion; and
wherein the diaphragm, the support element, the magnetic circuit, and the coil are at least partially disposed in the frame.

2. Loudspeaker according to claim 1, wherein said first inner edge of the inner annular portion extends around and surrounds a central aperture.

3. Loudspeaker according to claim 2, wherein the support element comprises a shaped body having a base attached to the core of the magnetic circuit, and an upper portion having a first attachment surface, substantially parallel to the base, to which said first inner edge is fixed, and a centering tooth which rises from the first attachment surface, substantially along the reference axis, and is inserted passing through said central aperture.

4. Loudspeaker according to claim 3, wherein said frame has a shaped body having a second attachment surface to which said second outer edge of the outer annular portion is fixed, said second attachment surface lying in a transverse plane with respect to the reference axis.

5. Loudspeaker according to claim 4, wherein said first and second attachment surfaces lie in two corresponding planes spaced apart and substantially parallel to each other.

6. Loudspeaker according to claim 3, wherein said frame has a shaped body having a wall with a substantially cylindrical configuration which is arranged around the yoke and has, at an upper inner edge thereof, a protruding tooth.

7. Loudspeaker according to claim 6, wherein the side wall of the yoke has, at its upper outer edge, a step suitable for resting against said protruding tooth.

8. Loudspeaker according to claim 1, wherein the coil comprises an armature around which is arranged at least one winding, said armature being attached, along an upper edge thereof, to the intermediate annular portion of the diaphragm.

9. Loudspeaker according to claim 1, wherein the support element comprises a shaped body having a base attached to the core of the magnetic circuit, and an upper portion having a first attachment surface, substantially parallel to the base, to which said first inner edge is fixed.

10. Loudspeaker according to claim 9, wherein said frame has a shaped body having a second attachment surface to which said second outer edge of the outer annular portion is fixed, said second attachment surface lying in a transverse plane with respect to the reference axis.

11. Loudspeaker according to claim 10, wherein said first and second attachment surfaces lie in two corresponding planes spaced apart and substantially parallel to each other.

12. Loudspeaker according to claim 1, wherein said frame has a shaped body having a wall with a substantially cylindrical configuration which is arranged around the yoke and has, at an upper inner edge thereof, a protruding tooth.
